(19) United States
(12) Patent Application Publication
(10) Pub. No.: US 2009/0078628 A1
(43) Pub. Date: Mar. 26, 2009

(54) Pool filtration system

(75) Inventor: Michael A. Stetson, Lake Elsinor, CA (US)

Correspondence Address: STETINA BRUNDA GARRED & BRUCKER, 75 ENTERPRISE, SUITE 250, ALISO VIEJO, CA, 92656, US

(73) Assignee: Stetson Development, Inc.

(21) Appl. No.: 11/903,060

(22) Filed: Sep. 20, 2007

(51) Int. Cl. B01D 35/02; C02F 1/00; E04H 4/16

(52) U.S. Cl. 210/167.1

(57) ABSTRACT

A filtration grid cover pre-impregnated with a filtering media such as diatomaceous earth is provided. The cover may have a pouch configuration sized and configured to receive a filtration grid of a diatomaceous earth filtration system. The entry aperture of the cover may be positioned at a top edge, side edge or bottom of the cover. The filtering media may be pre-impregnated on an inner surface or an outer surface of the cover. Various means of enclosing the filtration grid in the cover is disclosed or are disclosed such as with buttons, hooks and loops, adhesives, etc.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a pool filtration system.

Pool water is generally filtered to remove fine particulate from the water and enables the owner and its guests to swim in a clear, clean pool. There are three basic types of filters, namely, a sand filter, a diatomaceous earth filter, and a cartridge filter. Cartridge filters use a paper type cartridge as the filter media. Cartridge filters are easy to maintain since they are cleaned typically once or twice a season by simply hosing them off. In terms of particle size filtered out by the cartridge filter, cartridge filters filter out particle sizes somewhere between sand filters and diatomaceous earth filters.

In relation to sand filters, water is pushed through a bed of filter sand and removed through a set of exit tubes at the bottom of the sand tank. In operation, as the water goes down through the bed of filter sand, dirt and debris are trapped between the grains of sand. When the water reaches the bottom of the filter, the water enters the exit tubes and return to the pool. Unfortunately, the sand filter must be cleaned once every few weeks thereby increasing the cost of maintenance.

FIG. 1 illustrates a pool filtration system utilizing a diatomaceous earth filter to filter out debris and dirt from the pool water. In particular, the diatomaceous earth filter may have a plurality of filtration grids arranged in a fan configuration or a plurality of circular filtration grids. The plurality of filtration grids are disposed within a filter tank. The filter tank is pressurized with unfiltered pool water via the pump of the filtration system. Each of the filtration grids are impregnated with diatomaceous earth (i.e., the filter media). The unfiltered pool water is pushed through the diatomaceous earth impregnated on the filtration grids and flowed out of the exit tubes at the top of each of the filtration grids. The pool water flowing out of the exit tubes of the filtration grids are filtered by trapping the dirt and debris within the diatomaceous earth. Beneficially, the diatomaceous earth is able to filter out smaller particulate compared to sand or cartridge filters.

Diatomaceous earth is mined and is the fossilized exoskeletons of tiny diatoms. They are impregnated onto the filtration grids in the filter tank and act as tiny sieves to remove debris. Unfortunately, to clean diatomaceous earth filters, the filtration grids are removed from the filter tank. The pool maintenance personnel hoses down the filtration grids to remove the diatomaceous earth from the exterior of the filtration grids. The diatomaceous earth typically runs down the sewer. However, certain cities are not capable of handling the diatomaceous earth runoff due to the toxicity of the diatomaceous earth. As such, certain cities have banned the use of diatomaceous earth filters.

Another deficiency of diatomaceous earth filters is in the manner in which the diatomaceous earth is impregnated on or coated onto the filtration grids. In particular, the diatomaceous earth may not be evenly distributed over the filtration grids. As such, unfiltered pool water is more likely to flow through the less coated or less impregnated portion of the filtration grid due to less resistance to water flow. This reduces the effectiveness of the filtering process.

Simply put, pool water is not fully filtered after passing through the diatomaceous earth filter and returning to the pool. The filtration grid is not evenly distributed with diatomaceous earth due to the manner in which the filtration grid is coated or impregnated with diatomaceous earth. In particular, the diatomaceous earth is either poured directly into the skimmer or first formed as a slurry and then poured into the skimmer. The pump of the filtration system pumps the pool water and diatomaceous earth mixture from the skimmer into the filter tank. The filtration grid has a liner or outer surface which is permeable to water but impermeable to the diatomaceous earth. As such, as the diatomaceous earth and pool water combination passes through the filtration grid, the pool water is allowed to pass through the filtration grid and return back to the pool while the diatomaceous earth is impregnated onto the liner or outer surface of the filtration grid. The distribution of the diatomaceous earth on the filtration grid is dependent upon the flow of water in the filter tank. Accordingly, the diatomaceous earth is not evenly distributed about the entire filtration grid. Hence, the unfiltered pool water is not effectively filtered.

In sum, prior art diatomaceous earth filters suffer from at least two deficiencies. First, the diatomaceous earth itself is toxic and causes problems in many sewer systems of cities. Second, the diatomaceous earth is not evenly distributed over the entire surface of the filtration grid thereby allowing unfiltered pool water to flow through the diatomaceous earth filter and return to the pool.

The prior art has attempted to address the toxicity of the diatomaceous earth by producing or fabricating a replacement filtering media called Fiber Clear®. Unfortunately, Fiber Clear® is also unevenly distributed or impregnated onto the filtration grid such that the filtering system is not effective and allows unfiltered pool water to pass through the filtration system and return to the pool.

### BRIEF SUMMARY

The diatomaceous earth filtration grid cover discussed herein addresses the deficiencies discussed above, below and those that are known in the art. The filtration grid cover is a separate component from the filtration grid. The filtration grid cover is or may be pre-impregnated with filtering media (e.g., diatomaceous earth or Fiber Clear®) such that the filtering media is evenly distributed on the filtration grid cover. During regular pool maintenance, the filtration grid may be inserted into the filtration grid cover. In this manner, the filtering media is evenly distributed on the filtration grid. The even distribution of the filtering media on the filtration grid assists or promotes effective filtration of the unfiltered pool water.

The filtering media may be disposed on an inner side or an outer side of the filtration grid cover. When the filtering media is disposed on the inner side of the cover, the filtering media comes in direct contact with the liner of the filtration grid during operation of the diatomaceous earth filtration system. Nonetheless, a majority of the filtering media may remain pre-impregnated on the inner surface of the filtration grid cover and is not transferred to the liner of the filtration grid. As such, during regular maintenance of the filtration system, the maintenance personnel need only remove the filtration grid cover from the filtration grid. The used filtration grid may be disposed of in a trashcan and any filtering media on the filtration grid may be brushed off into a trashcan. A new filtration grid cover with clean filtering media may now be disposed over the filtration grid.

It is also contemplated that the filtering media may be disposed on an outer surface of the filtration grid cover. In this embodiment, the filtering media does not come in contact with the liner or outer surface of the filtration grid. To service the filtration system, the cover may be removed from the filtration grid. Optionally, the cover may be turned inside out to contain the filtering media in the cover. The used cover may now be disposed of in a trashcan.

Various means of securing the filtration grid cover to the filtration grid are disclosed herein. By way of example and not limitation, the cover may be secured to the filtration grid via a draw string, buttons, hooks and loops, adhesives, snaps, etc.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an illustration of a prior art pool filtration system utilizing a diatomaceous earth filter;

FIG. 2A is an exploded perspective view of a first prior art filtration grid;

FIG. 2B is a perspective view of a second prior art filtration grid;

FIG. 3 is an exploded view of a first embodiment of a cover pre-impregnated with a filtering media, the cover is sized and configured to receive the filtration grid from a top of the cover;

FIG. 3A is a cross sectional view of the cover shown in FIG. 3 illustrating filtering media pre-impregnated on an inner surface of the cover;

FIG. 4 is an exploded perspective view of a second embodiment of the cover sized and configured to receive a filtration grid;

FIG. 5 is an exploded view of a third embodiment of the cover sized and configured to receive the filtration grid;

FIG. 6 is an exploded view of a fourth embodiment of the cover sized and configured to receive the filtration grid;

FIG. 7 is an exploded view of a fifth embodiment of the cover sized and configured to be disposable adjacent opposed sides of the filtration grid;

FIG. 8 illustrates one of the first or second sheets of the cover shown in FIG. 7 with filtering media pre-impregnated on an outer surface or side of the first or second sheets;

FIG. 9 is a sixth embodiment of the cover;

FIG. 10 illustrates a seventh embodiment of the cover;

FIG. 10A illustrates the first and second sheets of the cover shown in FIG. 10 attached to each other and disposed on opposed sides of the filtration grid; and

FIG. 11 is an exploded view of an eighth embodiment of the cover sized and configured to receive a cartridge style filtration grid.

### DETAILED DESCRIPTION

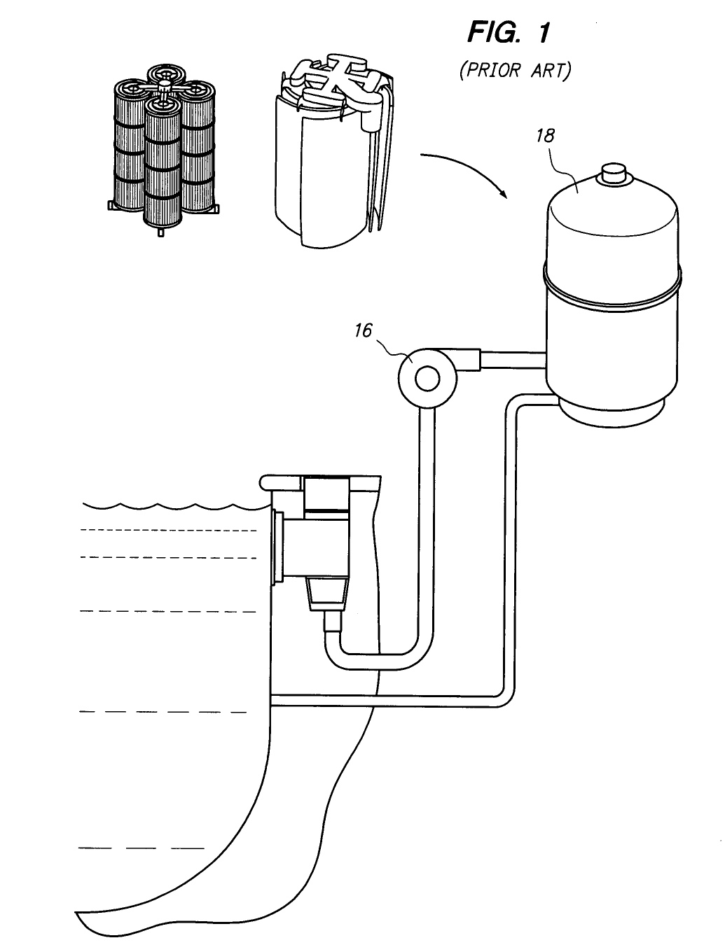

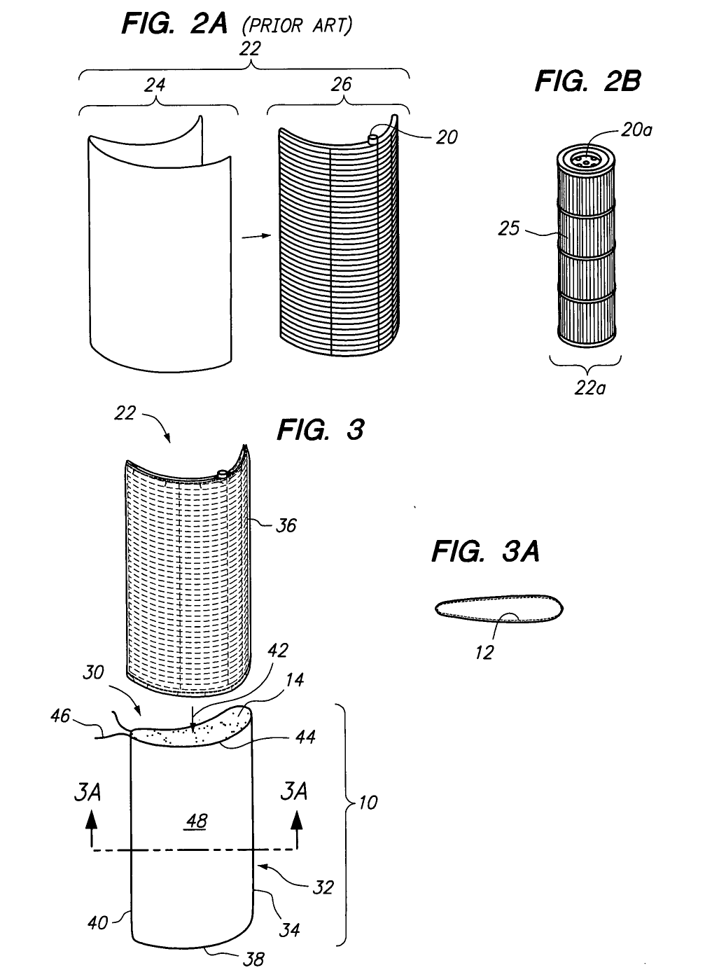

Referring now to FIGS. 3-11, various embodiments of a disposable cover 10 pre-impregnated with a filtering media 12 are shown. In an aspect of the disposable cover 10, the filtering media 12 is evenly pre-impregnated on at least a portion of the cover 10. By way of example and not limitation, the effective area through which pool water is filtered is evenly and sufficiently distributed with the filtering media 12 so as to effectively filter the incoming pool water. In another aspect of the cover 10, the filtering media 12 is pre-impregnated on an inner surface 14 of the cover 10 (see FIG. 3A). During normal operation, the filtration system's pump 16 pressurizes the tank 18 of the filtration system, as shown in FIG. 1. The inside surface 14 of the cover 10 is pressed against the liner 24 (see FIG. 2A) of the filtration grid 22 while the pump is on. For a circular type filtration grid 22a (see FIG. 2B), the inside surface 14 of the cover 10 is pressed against the outer surface 25 of the filtration grid 22a while the pump is on. Each of the exit tubes 20, 20a of the filtration grid 22, 22a has a low pressure. As such, unfiltered pool water flows from outside of the cover 10 to within the filtration grid 22, 22a and through the exit tube 20, 20a of the filtration grid. Nonetheless, a majority of the filtering media 12 remains on the cover and is not transferred to the liner 24 or outer surface 25 of the filtration grid 22, 22a. As such, when the filtering media 12 is scheduled to be replaced, maintenance personnel removes the cover 10 from the filtration grid 22, 22a thereby removing substantially all of the filtering media 12 from the filtration grid 22, 22a. The filtering media 12 still remaining on the liner 24 or outer surface 25 may be hosed off or brushed off into a trashcan. The majority of the filtering media 12 remains within the cover 10 and may be disposed of in the trash can.

The cover 10 may be fabricated from a permeable membrane. By way of example and not limitation, the permeable membrane may be a polyethylene material, a polyethylene material that is spun and/or woven, cellulose fiber material, cotton, nylon, or other materials that are water permeable and known in the art or developed in the future. The inner surface 14 of the cover 10 may be pre-impregnated with a filtering media 12 such as diatomaceous earth or a diatomaceous earth substitute (e.g., Fiber Clear®).

Referring to FIG. 3, cover 10 may be sized and configured to receive the filtration grid 22 within the cover 10. In particular, the cover 10 may have a first layer 30 defining an outer periphery. The cover 10 may additionally have a second layer 32 also defining an outer periphery. The outer peripheries of the first and second layers 30, 32 may be attached to each other to form the cover 10. For example, a large sheet of a permeable membrane may be folded in half, the folded line 34 may form an edge of the cover 10 which mates with a first edge 36 of the filtration grid 22. The bottom edge 38 and the left edges 40 may be stitched together to form the pouch configuration of the cover 10. The cover 10 may have an entry aperture 42 sized and configured such that the filtration grid 22 may be slid into the cover 10 and slipped out of the cover 10 for maintenance. The entry aperture 42 may have or be defined by a periphery 44. A draw string 46 may be sewn into the periphery 44 of the entry aperture 42. Opposed distal ends of the draw string 46 may be routed out of the periphery 44. To securely attach the cover 10 to filtration grid 22, the draw string 46 may be pulled until the periphery 44 of the cover 10 is small enough such that the filtration grid 22 cannot be slipped out of the cover 10, and more preferably, the periphery 44 closes upon the outer periphery of the exit tube 20 of the filtration grid 22. The draw string 46 is then tied such that the periphery 44 of the cover 10 does not become loose and slip off of the filtration grid 22 during operation of the diatomaceous earth filter.

In the embodiment of the cover 10 shown in FIG. 3, it is preferred that the first and second layers 30, 32 of the cover 10 be fabricated from a stretchable material such that the periphery 44 may be closed over the filtration grid 22 as discussed above.

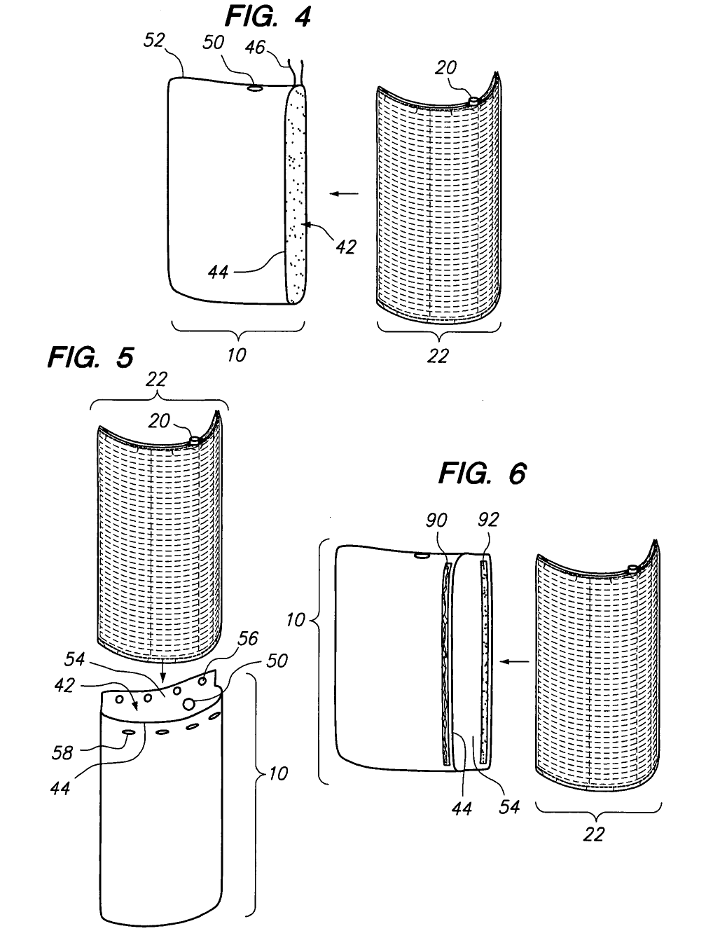

Although the cover 10 shown in FIG. 3 is described as having an entry aperture 42 at its upper end, it is also contemplated that the entry aperture may be located on its bottom end or sides (see FIG. 4). It is further contemplated that the entry aperture 42 may also be located one or more inches midway on the first or second layers 30, 32.

Moreover, although the filtering media 12 may be disposed on the inner surface 14 of the cover -10 as shown in FIG. 3A, it is also contemplated that the filtering media 12 may be pre-impregnated or disposed on an outer surface 48 of the cover 10. In this regard, the filtering media 12 does not contact the liner 24 of the filtration grid 22. When the filtration system is ready to be serviced, the cover 10 is simply removed from the filtration grid and (optionally) inverted inside out to contain the diatomaceous earth in the cover 10. The filtration grid 22 does not have to be hosed down. Rather, a new cover 10 with fresh filtering media 12 may be slipped over the filtration grid 22. More beneficially, the filtering media 12 is not washed into the sewer which may be detrimental to the city's sewer system.

Referring now to FIG. 4, the entry aperture 42 of the cover 10 is located on a side of the cover 10. The filtration grid 22 is inserted and removed from the cover 10 via the side of the cover 10. The cover 10 may additionally have an exit tube aperture 50 formed at a top edge 52 of the cover 10. To insert the filtration grid 22 into the cover 10, the side of the filtration grid 22 is aligned to the entry aperture 42 of the cover 10. The cover 10 is then slipped over the filtration grid 22. When the periphery 44 of the cover 10 contacts the exit tube 20 at the top of the filtration grid 22, the cover 10, being preferably fabricated from a stretchable material, is stretched out and over the exit tube 20. The cover 10 is then further slipped over the filtration grid 22 until the exit tube 20 is received into the exit tube aperture 50 of the cover 10. The draw strings 46 are tightened to prevent the cover 10 from slipping off of the filtration grid 22.

Although the cover 10 is preferably fabricated from a stretchable material, it is also contemplated that the cover 10 may be fabricated from a non-stretchable material. By way of example and not limitation, the periphery 44 of the cover 10 may be oversized such that the periphery 44 of the cover 10 may be slipped over the exit tube 20 and the exit tube 20 received into the exit tube aperture 50 of the cover 10.

Similar to the cover 10 shown in FIGS. 3 and 3A, the filtering media 12 may be coated or pre-impregnated on the inner surface 14 or the outer surface 48 of the cover 10.

Referring now to FIGS. 5 and 6, alternative methods or means of closing the cover 10 so as to secure the cover 10 on the filtration grid 22 are shown. In FIG. 5, a closure flap 54 may be attached to the periphery 44 of the cover 10. The closure flap 54 may have a plurality of buttons 56 attached to the closure flap 54. Correspondingly, the opposed side of the cover 10 may have plurality of corresponding button slits 58. In use, the filtration grid 22 may be slipped into the cover 10 through the entry aperture 42. Once the filtration grid 22 is fully inserted into the cover 10, the closure flap 54 may be pulled upward so as to stretch the cover 10 until the exit tube 20 of the filtration grid 22 is received into the exit tube aperture 50. The buttons 56 are engaged to the corresponding button slits 58 to close the cover 10 and secure the cover 10 to the filtration grid 22. The location of the entry aperture 42 and the closure flap 54 may be alternatively at the sides or bottom of the cover 10 instead of the top of the cover 10 as shown. When the entry aperture 42 and the closure flap 54 are formed at a bottom of the cover 10, then the top portion of the cover 10 may have an exit tube aperture 50 which receives the exit tube 20 once the filtration grid is fully inserted into the cover 10. Although the buttons 56 are shown as being attached to the inner surface of the closure flap 54, it is also contemplated that the buttons 56 may be attached to the outer surface of the closure flap 54. To seal the closure flap 54, the closure flap is folded over the top of the filtration grid 22 and tucked into the cover 10. The buttons 56 are fed through corresponding button slits 58 to seal the cover 10.

FIG. 6 illustrates hooks and loops as the closure means of securing the closure flap 54 to the cover 10. Similar to the cover 10 shown in FIGS. 3, 4 and 5, the cover 10 shown in FIG. 6 may alternatively incorporate an entry aperture 42 at the top, or bottom of the cover 10. A first part 90 of the hooks and loops system may be attached to an outer surface of the cover 10. A corresponding second part 92 of the hooks and loops system may be attached to an inner surface of the closure flap 54. After the filtration grid 22 is inserted into the cover 10, the closure flap 54 is folded over the filtration grid 22 as well as the periphery 44 of the entry aperture 42. The first and second parts 90, 92 of the hooks and loops system are engaged to each other to seal the filtration grid 22 within the cover 10. Alternatively, the first part 90 of the hooks and loops system may be attached to an inner surface of the cover 10. A corresponding second part 92 may be attached to the outer surface of the closure flap 54. After the filtration grid 22 is inserted into the cover 10, the closure flap 54 may be folded over the filtration grid 22 and tucked into the cover 10. The first and second parts 90, 92 of the hooks and loops system are engaged to each other to seal the filtration grid 22 in the cover 10. The first and second parts 90, 92 of the hooks and loops system may respectively be hooks and loops, or loops and hooks.

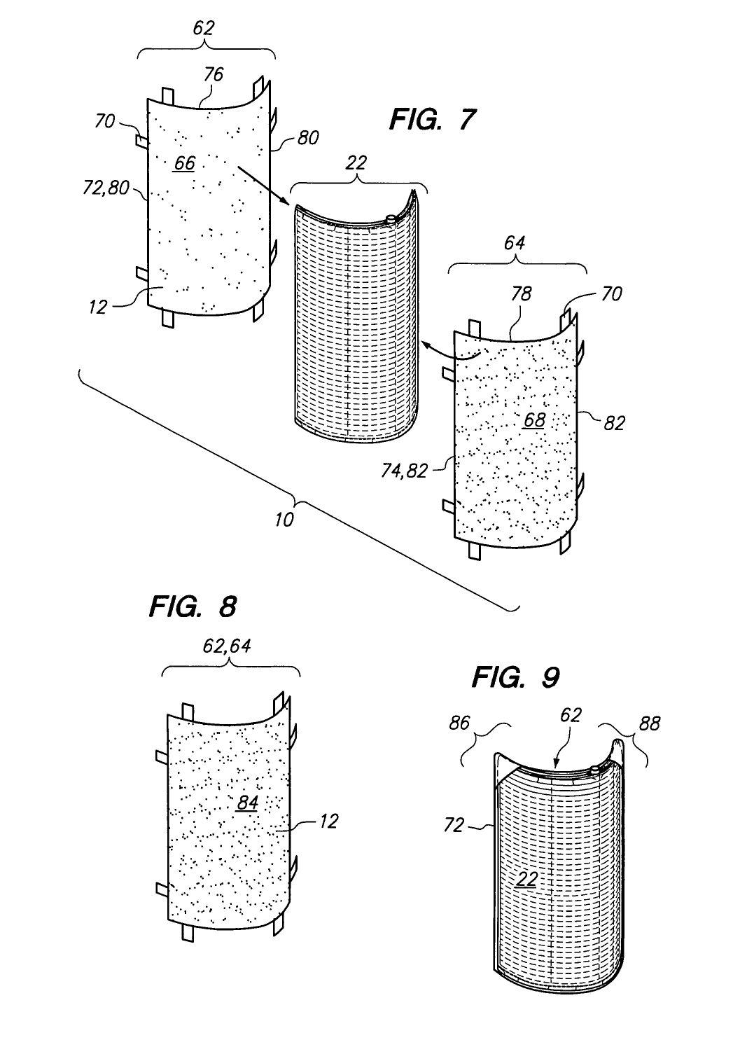

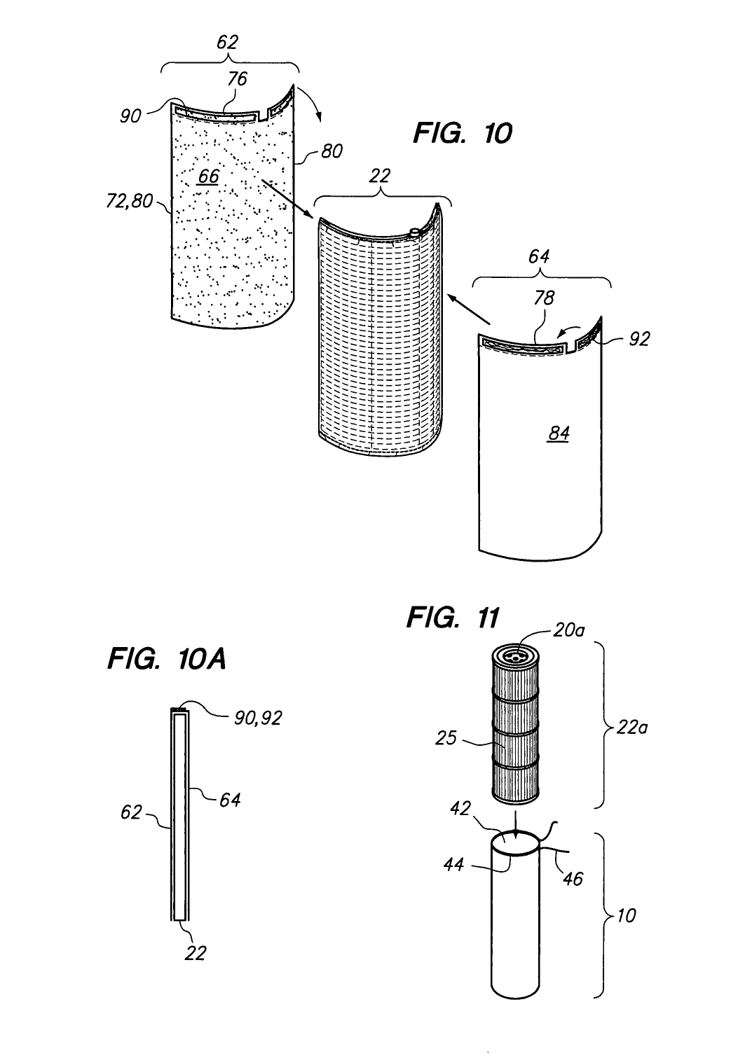

Referring now to FIGS. 7-10A, the cover 10 may comprise a first sheet 62 and a second sheet 64. The first and second sheets 62, 64 may be disposed adjacent opposed sides of the filtration grid 22, as shown in FIGS. 7 and 10. The first and second sheets 62, 64 may have filtering media 12 coated or pre-impregnated on the inner sides 66, 68 of the first and second sheets 62, 64. As shown in FIG. 7, the first and second sheets 62, 64 may additionally have various attachment members 70 secured to the periphery 72, 74 of the first and second sheets 62, 64. For example, a first part of a hooks and loops system may form the attachment members 70 attached to the periphery 72 of the first sheet 62. A mating second part of the hooks and loops system may form the attachment members 70 attached to the periphery 74 of the second sheet 64. To install the first and second sheets 62, 64 on the filtration grid 22, the inner sides 66, 68 of the first and second sheets 62, 64 are laid adjacent the opposed sides of the filtration grid 22. Corresponding attachment members 70 of the first and second sheets 62, 64 are engaged to each other. The attachment members 70 attached to the top edges 76, 78 of the first and second sheets 62, 64 prevent the first and second sheets from sliding down during installation of the filtration grid into the filter tank. The attachment members 70 attached to the lateral edges 80, 82 of the first and second sheets 62, 64 prevent lateral movement of the first and second sheets 62, 64 during installation of the filtration grid 22 of the filter tank.

Although the filtering media 12 is shown as being pre-impregnated on the inner sides 66, 68 of the first and second sheets 62, 64, it is also contemplated that the filtering media 12 may be pre-impregnated on the outer side 84 of the first and/or second sheets 62, 64. This alternative embodiment is shown in FIG. 8.

During use, the pump pressurizes the filter tank and flows water through the first and second sheets 62, 64 and presses the first and second sheets 62, 64 on the opposed sides of the filtration grid 22. The pressure from the water and flow of water through the first and second sheets 62, 64 may be sufficiently strong to prevent any movement of the first and second sheets 62, 64 with respect to the filtration grid 22. When the pump is off, the attachment members 70 about the periphery 72, 74 of the first and second sheets 62, 64 prevent downward or lateral movement of the first and second sheets with respect to the filtration grid 22.

Referring now to FIG. 9, the first sheet 62 is shown. The second sheet 64 may be identical to the first sheet 62 but attached to the filtration grid 22 on the opposing side (not shown). However, instead of attaching attachment members 70 to the periphery 72, 74 of the first and second sheets 62, 64, upper opposed corners of the first and second sheets 62, 64 may have corner pockets 86, 88. The corner pockets 86, 88 are formed by securing a smaller layer to the opposed upper corners of the first and second sheets 62, 64. The lateral and top edges of the corner pockets 86, 88 are attached to the periphery 72, 74 of the first and second sheets 62, 64.

In use, the first sheet 62 is attached to one side of the filtration grid 22 by hooking the corner pockets 86, 88 over the opposed upper corners of the filtration grid 22, as shown in FIG. 9. A second sheet 64 (not shown) may also be hung over the upper corners of the filtration grid 22 by engaging its corner pockets 86, 88 to the opposed upper corners of the filtration grid 22. Since the pool water flows through the large surface area of the filtration grid 22, all of the pool water flowing through the filtration system is filtered by the filtering media 12 pre-impregnated onto the first and second sheets 62, 64. To dispose of the first and second sheets 62, 64, the maintenance personnel need only lift the first and second sheets 62, 64 off of the filtration grid 22 and throw them away into a trashcan.

The filtering media 12 may be pre-impregnated or coated onto the inner sides 66, 68 of the first and second sheets 62, 64. Alternatively or additionally, it is also contemplated that the filtering media 12 may be coated and pre-impregnated on the outer side 84 of the first and second sheets 62, 64. Moreover, in the alternative, the first and second sheets 62, 64 may each be formed by two separate layers with the filtering media 12 disposed between those two separate layers. In this manner, the filtering media 12 does not contact the opposed sides of the filtration grid 22 or the liner 24 of the filtration grid 22. Also, the filtering media 12 does not become loose. Rather, the filtering media 12 is encased in or between the two layers defining the first sheet 62 and the two layers defining the second sheet 64. The first and second sheets 62, 64 may be conveniently disposed of in a trashcan during the scheduled maintenance of the filtration system.

Referring now to FIG. 10, the first and second sheets 62, 64 may be attached to each other with hooks and loops. By way of example and not limitation, the inner side 66 of the first sheet 62 may be formed with a first part 90 of the hooks and loops system. An outer side 84 of the second sheet 64 may be formed with a second part 92 of the hooks and loops system. The first and second parts 90, 92 of the hooks and loops system may be either the hooks and loops or the loops and hooks, respectively. The first and second parts 90, 92 of the hooks and loops system may be attached to the upper portion of the first and second sheets 62, 64. To attach the first and second sheets 62, 64 to the filtration grid 22, the first sheet 62 is folded forward as shown in FIG. 10A. The second sheet 64 is then folded backwards such that the first and second sheets 62, 64 are in contact and secured to each other. The weights of the first and second sheets 62, 64 are draped over the top edge of the filtration grid 22. A cutout may be made in the top edges of the first and second sheets 62, 64 to allow for the exit tube 20 in the filtration grid 22.

In an aspect of the filtration grid cover 10, it is contemplated that the filtration grid cover 10 may be used on conjunction with only the frame 26 of the filtration grid 22. More particularly, prior art filtration grids 22 comprise a liner 24 and a frame 26, as shown in FIG. 2A. The liner 24 surrounds the entire frame 26. It is contemplated that the liner 24 may be removed from the frame 26. The liner 24 may now be thrown away in a trashcan. The frame 26 may now be inserted into the cover 10 and secured therein as discussed above in relation to FIGS. 3-10A. Preferably, when the liner 24 is removed from the frame 26, the filtering media 12 is disposed on an outer surface of the cover 10.

It is also contemplated that the cover 10 may be secured to the filtration grid 10 with adhesives or snaps. By way of example and not limitation, the attachment members 70 may be formed of pressure adhesive or corresponding snaps instead of hooks and loops. Also, the closure flap 54 and cover 10 may be formed with pressure adhesive or snaps. For example, the first and second parts 90, 92 of the hooks and loops system may be replaced with snaps or adhesive (e.g., pressure adhesive).

Referring now to FIG. 11, a cover 10 for a circular filtration grid 22a is shown. The cover 10 may have a pouch configuration sized and configured to receive the filtration grid 22a. To install the cover 10 on the filtration grid 22a, the entry aperature 42 of the cover 10 is opened such that the filtration grid 22a may be inserted into the cover 10. The filtration grid 22a may be fully inserted into the cover 10 until the periphery 44 is disposed adjacent an upper end of the filtration grid 22a. To secure the cover 10 to the filtration grid 22a, the periphery 44 of the entry aperture 42 of the cover 10 may be formed with a draw string 46. The draw string 46 may be sewn into the periphery 44 of the cover 10. The draw string 46 may freely slide through the periphery 44 such that the draw string 46 may be tightened to reduce the size of the aperture 42. With the filtration grid 22a disposed in the cover 10 and the cover periphery 44 adjacent the upper end of the filtration grid 22a, the draw string 46 may be tightened and tied. In this manner, the cover 10 may not slide down the filtration grid 22a. The draw string 46 may be tightened in a manner that the periphery 44 does not interfere with the function of the manifold which is inserted into the exit tube 20a of the filtration grid 22a. During operation, the pump pressurizes the tank 18 of the filtration system. The cover 10 is pressed against the outer surface 25 of the filtration grid 22a. The unfiltered pool water flows from outside of the cover 10 to within the filtration grid 22a and exits through exit tube 20a of the filtration grid 22a.

The cover 10, as discussed above, may have filtering media 12 evenly pre-impregnated on at least the effective filtering area of the cover 10. The filtering media 12 may be pre impregnated on the entire cover 12. Also, the filtering media 12 may be disposed on an inner surface or an outer surface of the cover 10.

The draw string 46 may be tightened and tied to ensure that the cover 10 does not slip off of the filtration grid 22a. It is also contemplated that the periphery 44 of the aperture 42 of the cover 10 may be formed with an elastic band. When the periphery 44 of the cover 10 is disposed above the upper end of the filtration grid 22a, the elastic band reduces the size of the aperture 42 to hold the cover 10 up on the filtration grid 22a. It is also contemplated that the cover 10 may be secured to the filtration grid 22a through the use of adhesive, snaps, buttons, and other attachment mechanisms.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A pool filtration grid for removing particulate in pool water, the grid comprising:
a frame defining opposed first and second sides, the frame having a web configuration for allowing pool water to flow through the webbed frame;
a water permeable membrane attachable to the frame; and
a filter media pre-impregnated on at least a portion of the water permeable membrane, the filter media operative to capture the particulate when water flows through the webbed frame.

2. The pool filtration grid of claim 1 wherein the filtering media is evenly distributed on at least a portion of the membrane.

3. The pool filtration grid of claim 1 wherein the membrane defines an effective flow area through which a majority of the pool water flows and the filtering media is evenly distributed over the effective flow area of the membrane.

4. The pool filtration grid of claim 1 wherein the membrane is fabricated from cellulose fiber.

5. The pool filtration grid of claim 1 further comprising a liner disposed between the frame and the membrane.

6. The pool filtration grid of claim 1 wherein the membrane comprises:
a first layer defining an outer peripheral portion;
a second layer defining an outer peripheral portion, the outer peripheral portions of the first and second layers being attached to each other to form a pouch defining an inner surface;
wherein the filtering media is pre-impregnated on the inner surface of the pouch.

7. The pool filtration grid of claim 5 wherein the liner is a mesh.

8. The pool filtration grid of claim 6 wherein the pouch is closeable with hooks and loops, adhesive, buttons, ties, snaps or elastic band.

9. The pool filtration grid of claim 1 wherein the membrane is polyethylene material.

10. The pool filtration grid of claim 9 wherein the polyethylene material is spun and woven.

11. The pool filtration grid of claim 1 wherein the filtering media is diatomaceous earth or diatomaceous earth substitute.

12. The pool filtration grid of claim 1 wherein the frame has an arc shape.

13. A pool filtration assembly for removing particulate in pool water, the assembly comprising:
a filtration grid defining an exit aperture and an exterior side;
a water permeable membrane disposed on an exterior side of the filtration grid and having an aperture sized and configured to the exit aperture of the filtration grid to allow the pool water to exit the filtration grid; and
a filtering media pre-impregnated on at least a portion of the water permeable membrane, the filtering media operative to capture the particulate when water flows through the filtration grid.

14. The pool filtration assembly of claim 13 wherein the water permeable membrane has a pouch configuration sized and configured to receive the filtration grid.

15. The pool filtration assembly of claim 13 wherein the filtration grid has a circular configuration.

16. A cover for a pool filtration grid, the cover comprising:
a water permeable membrane disposable on an exterior side of the pool filtration grid, the water permeable membrane defining an aperture sized and configured to an exit aperture of the pool filter grid to allow water to flow through the exit aperture of the pool filter grid;
a filtering media pre-impregnated on at least a portion of the water permeable membrane, the filtering media operative to capture the particulate when water flows through the filter grid.

17. The cover of claim 16 wherein the filtering media is pre-impregnated on an inner surface of the water permeable membrane.

18. The cover of claim 16 wherein the water permeable membrane is polyethylene material.
